(19) United States
(12) Patent Application Publication
(10) Pub. No.: US 2014/0373798 A1
(43) Pub. Date: Dec. 25, 2014

(54) HEAT EXCHANGER, IN PARTICULAR FOR A VEHICLE COMPRISING A HEAT ENGINE

(71) Applicant: Valeo Systemes de Controle Moteur, Cergy Saint Christophe (FR)

(72) Inventors: Damien Alfano, Le Pecq (FR); Pauline Lartigue, Argenton (FR); Thierry Cheng, Les Brevieres (FR); José Antonio De La Fuente, Alagon Zaragoza (ES)

(21) Appl. No.: 14/375,555

(22) PCT Filed: Jan. 31, 2013
(86) PCT No.: PCT/FR2013/050202

§ 371 Date: Jul. 30, 2014

(30) Foreign Application Priority Data
Feb. 3, 2012 (FR) 1251013

(51) Int. Cl. F02N 19/02; F28D 7/16; F28D 15/00; F01N 5/02; F24J 1/00

(52) U.S. Cl. CPC F02N 19/02; F01N 5/02; F24J 1/00; F28D 15/00; F28D 7/16
USPC 123/142.5 R; 60/320; 126/263.02; 165/104.28; 165/154

(57) ABSTRACT

The invention relates to a heat exchanger (1) for a vehicle comprising a heat engine, said exchanger comprising a first circuit, a second circuit and a tank. According to the invention, the first circuit comprises first ducts for conveying exhaust gases, the second circuit comprises second ducts for conveying a heat-transfer fluid, and the tank can receive a reagent.

The present invention relates to a heat exchanger, in particular for a vehicle comprising a combustion engine.

Such an exchanger can be used for example to heat the combustion engine of the vehicle during its starting operation. Heating the combustion engine when the vehicle starts can make it possible to reduce the consumption of petrol and/or the emissions of pollutants. Under very cold conditions, this heat can also be transmitted to the passenger compartment to improve the comfort of the users of the vehicle.

Existing solutions for heating a combustion engine during the starting operation of a vehicle are for example: the use of a pre-heat plug, the encapsulation of the engine, the enrichment of the air/fuel mixture to more rapidly obtain better engine performance, the use of external heating elements fastened to the bottom of the engine block or else the use of an immersion heater which is immersed in the oil of the engine block.

These various solutions are not actually satisfactory in terms of consumption and/or of cost and/or of service life and/or of efficiency in the transfer of heat to the combustion engine.

Reagents which can be involved in exothermic reactions are known.

There is a need to have available a heat exchanger which makes it possible to use the heat released by such exothermic reactions, in particular in order to heat a vehicle combustion engine.

The aim of the invention is to meet this need and it achieves this, according to one of its aspects, with the aid of a heat exchanger for a vehicle, the vehicle comprising in particular a combustion engine, the exchanger comprising a first circuit, a second circuit and a reservoir, the first circuit comprising first ducts capable of conveying exhaust gases, the second circuit comprising second ducts capable of conveying a heat-transfer fluid, and the reservoir being capable of receiving a reagent.

The exchanger may comprise an enclosure inside which are arranged the first circuit, the second circuit and the reservoir. The first circuit can be connected to accesses toward the interior of the enclosure to allow gases to enter and leave the first circuit.

The second circuit can be connected to at least two accesses toward the interior of the enclosure to allow fluid to enter and leave the second circuit.

The reservoir can be connected to at least one access toward the interior of the enclosure to allow the reservoir to be supplied with reagent and/or the reservoir to be supplied with a reaction fluid engaging with said reagent in an exothermic reaction in said reservoir.

The reservoir can then be configured to withstand this exothermic reaction, that is to say to be not degraded immediately or in the longer term by this exothermic reaction.

The reagent is in particular a solid reagent, for example zeolite.

The first circuit can convey exhaust gases, the second circuit can convey the heat-transfer fluid, preferably liquid for cooling a combustion engine, and the reservoir can receive the reagent, preferably the zeolite.

The reservoir can be traversed by the first and the second ducts.

The reagent can then be at least partly received in the space of the reservoir not occupied by the first and the second ducts. The reagent can be arranged completely or partly in the gaps between the ducts traversing the reservoir.

The reservoir can extend on either side of the first ducts and the second ducts.

Reaction fluid, such as water, can be poured into the reservoir and this water can come into contact with the zeolite so as to cause an exothermic reaction in which the water is adsorbed by the zeolite. The heat thus released can be recovered by the fluid circulating in the second duct and conveyed toward the combustion engine to heat the latter. The regeneration of the zeolite saturated with water after said exothermic reaction can be obtained by virtue of the passage of the exhaust gases through the first circuit. These gases can release heat, allowing the desorption of the water contained in the pores of the zeolite, such that the zeolite is again ready to react exothermically with water during a subsequent starting operation of the vehicle. The exchanger can thus make it possible to recover the heat released by the zeolite and to regenerate it subsequently.

Within the meaning of the present application, “water” must be understood broadly, equally denoting pure water and a mixture of water and a component or components in lesser proportion or proportions, such a mixture being, for example, glycol water.

The exchanger can be referred to as a “three-fluid exchanger” given that it can receive three fluids, for example water or more generally reaction fluid, the heat-transfer fluid and the exhaust gases.

Within the meaning of the present invention, “duct” can be understood as a synonym for “tube”, whether the tube has a circular or other cross section.

The first circuit and the second circuit can occupy part of the interior of the enclosure and the remainder of the interior of the enclosure can form the reservoir, that is to say that the reservoir can be formed by the gaps between the ducts in the enclosure.

The zeolite can be used in the form of balls, then forming beds of balls in the reservoir. In a variant, the zeolite can be used in the form of thin layers.

The zeolite can be anhydrous before its reaction with the water.

The second circuit and the reservoir are advantageously arranged in such a way that, when the reagent is subjected to an exothermic reaction, the heat released by this reaction is transmitted to the fluid circulating in the second ducts.

The first circuit and the reservoir are advantageously arranged in such a way that, when exhaust gases circulate in the first ducts, their heat is transmitted to the reagent in the reservoir.

When the reagent used is zeolite, the exchanger thus allows effective heat transfer, for example toward the combustion engine, while ensuring a regeneration of the zeolite.

The exchanger can be dimensioned to provide a power of the order of 15 kW for a duration of the order of two minutes in order to heat the combustion engine. The exchanger can also be dimensioned so that the regeneration of the zeolite by the exhaust gases is carried out for a duration between ten minutes and half an hour, for example twenty minutes.

The first circuit can comprise a plurality of first separate ducts extending substantially parallel to the longitudinal axis of the exchanger. These first ducts can be distributed uniformly or otherwise in the enclosure.

The second circuit can comprise at least one unit of second ducts connected to one another by junctions, the unit having one end forming an inlet of the unit and another end forming an outlet of the unit. The inlet and the outlet of the unit can each communicate with one of the two accesses toward the interior of the enclosure in order to respectively allow the fluid to enter and leave the unit.

The second circuit can be formed by a single unit or, in a variant, by a plurality of separate units. Each unit can form a layer having a coiled shape. Such a layer makes it possible for the fluid passing through a unit of the second circuit to satisfactorily receive the heat released by the exothermic reaction.

Each unit can extend in one plane.

When the second circuit comprises a plurality of units, each of these units can possess the same number of second ducts, so as to have the same head loss. Each unit is, for example, formed by between two and twenty second ducts connected in succession to one another. Between two and ten units, for example four units, can form the second circuit.

Each second duct can extend substantially parallel to the longitudinal axis of the exchanger.

The inlet and the outlet of the unit can be situated at the same height along the longitudinal axis of the exchanger, in particular at the same longitudinal end of the exchanger, in particular on either side of the longitudinal axis.

At least one second duct can open at at least one of its longitudinal ends into a space delimited by a pair of plates arranged transversely, in particularly perpendicularly, with respect to the longitudinal axis of the exchanger. Moreover, this space can be closed by the enclosure. The corresponding longitudinal ends of all or part of the second ducts of the second circuit open, for example, into said space.

In one particular exemplary embodiment of the invention, the exchanger is provided with at least two pairs of plates, each pair being at a distance from the other pair along the longitudinal axis of the exchanger, each pair being in particular arranged in the vicinity of a longitudinal end of the exchanger, and each pair of plates defines a space into which open the corresponding longitudinal ends of all or part of the second ducts.

The junction between two corresponding longitudinal ends of two second ducts of the unit can be formed by means of a strap surrounding a part of the space delimited by the pair of plates, said longitudinal ends of said second ducts opening into this part of the space. The junction can thus be formed other than by machining the ducts so that they have a bend. According to the foregoing, two rectilinear ducts are connected with the aid of a pair of plates and a strap.

Each plate of a pair can be traversed by the first ducts and only one of these two plates can be traversed by the second ducts involved in the junctions. The plate not traversed by the second ducts connected to one another in pairs by the junctions is, for example, arranged longitudinally between the other plate of the pair and the closest longitudinal end of the exchanger.

Each first or second duct can be fixed, for example by welding, to one plate only or both plates.

The plates of the same pair can be used for all the junctions of a unit or of the second circuit, at the same longitudinal end of the second ducts.

The strap can extend along the longitudinal axis of the exchanger over the whole distance between the two plates of the same pair. The distance between the two plates of the same pair is, for example, less than 1 cm, being in particular of the order of a few mm.

The exchanger can comprise an inlet zone of the unit or units of the second circuit and an outlet zone of the unit or units of the second circuit. The inlet zone and the outlet zone can be situated at the same height along the longitudinal axis of the exchanger. The inlet zone and the outlet zone can each form a manifold. Each manifold is in particular connected to one of the accesses toward the interior of the enclosure to allow the entry into the exchanger of the fluid intended to recover the heat released by the exothermic reaction and the exit of this fluid once this heat has been recovered to heat the combustion engine.

One of the inlet zone and the outlet zone can be radially exterior, with respect to the longitudinal axis, to the other of the inlet zone and the outlet zone.

The outlet zone and the inlet zone can be axially contained between two plates, one of these plates being in particular the plate above not traversed by the second ducts connected to one another by the junctions.

The exchanger can comprise a plurality of fins. These fins can make it possible to improve the heat transfers within the exchanger.

Each fin can contact at least one second duct. Moreover, each fin is immersed in the reservoir in order to promote the transfer of the heat induced by the exothermic reaction in the reservoir to the heat-transfer fluid in the second duct or ducts.

One and the same fin can contact only one second duct or a plurality of ducts, or even all the second ducts.

Each fin may not come into contact with the first ducts in order to avoid transmitting the heat of the exhaust gases to the fluid circulating in the second duct when the exhaust gases pass through the first circuit. That can also make it possible to favor the transfer of heat by the fins to the fluid in the second circuit and not to the first ducts when the exothermic reaction takes place in the reservoir.

According to one example of a fin, the latter takes the form of a thin support in which holes are provided. The thickness of this support is, for example, less than 1 cm, in particular less than 0.8 mm. According to this example, holes receive second ducts without clearance whereas other holes receive first ducts with clearance. In this way, the first ducts are not in contact with the fin whereas the second ducts are. The distance separating the first ducts from the closest fin can be between 1 mm and 2 mm.

When the ducts have a circular cross section, the holes formed in the fins for the ducts can be circular.

According to one exemplary embodiment of the invention, the fins are arranged transversely, in particular perpendicularly, with respect to the longitudinal axis of the exchanger, in succession to one another. Two adjacent fins can then delimit different compartments of the reservoir.

In a plane transverse, in particular perpendicular, to the longitudinal axis of the exchanger, each fin can extend substantially between two opposite edges of the enclosure.

In this case, in said plane, each fin can have a cross section which is smaller than the cross section of the exchanger between these two edges. A free space can thus exist in this plane, this free space making it possible for the different compartments of the reservoir to communicate with one another, thus facilitating the filling of the reservoir with reagent.

In a variant, in said plane, each fin can extend only between a central zone and an edge of the enclosure. A first fin extends between said central zone and a first edge of the enclosure whereas a second fin extends between the central zone and a second edge of the enclosure, said first and said second edges being opposed to one another with respect to the central zone. The first and second fins can then be arranged alternately along the longitudinal axis, this making it possible to promote the diffusion of water in the reservoir to cause the reaction with the reagent.

In this case, in said plane, each fin can have a cross section which is smaller than the cross section of the exchanger between the central zone and the edge of the enclosure. The fin extends, for example, over less than half of the cross section of the enclosure. The part of the half of the cross section of the enclosure not occupied by the fin can allow the communication between the different compartments of the reservoir, facilitating the filling of the reservoir with reagent.

In the case where the enclosure has a circular cross section, each fin can have a semicircular shape with the exception of a cutout, for example formed on its outer periphery. Thus, in a plane transverse, in particular perpendicular, to the longitudinal axis of the exchanger, the cross section of each fin is smaller than a half cross section of the enclosure on account of the cutout.

More generally, in a plane transverse, in particular perpendicular, to the longitudinal axis of the exchanger, each fin can have a cross section which is smaller than the cross section in this plane of the part of the exchanger in which it is arranged.

The ratio of the cross section of the fin to the cross section of the exchanger above can be obtained by machining already manufactured fins or fins at the manufacturing stage. The fins can thus be manufactured to have a cross section adapted to this ratio, for example by molding.

The first ducts may or may not have in cross section the same dimensions as the second ducts.

The invention also relates, according to another of its aspects, to a method for heating a component of a vehicle, in particular a combustion engine, with the aid of the exchanger above, in which method:
reaction fluid, in particular water, is poured into the reservoir into which there has previously been introduced a reagent engaging with said reaction fluid, in particular water, in an exothermic reaction, and
the heat-transfer fluid heated after its passage through the second circuit is brought into the vicinity of the component to be heated.

The method can comprise a step of regenerating the reagent, in which exhaust gases are circulated in the first circuit.

All or some of the features mentioned above with respect to the heat exchanger apply to the method.

The invention also relates, according to another of its aspects, to a junction system for joining at least two ducts, comprising:
a pair of plates arranged opposite one another and defining between them a space, one of the plates comprising at least two openings through which each duct opens respectively into the space, and
a strap extending from an edge of a plate of the pair to the opposite edge of the other plate of the pair,
   the strap being arranged in said space so as to surround said openings to form a leaktight communication zone between the two ducts.

The above aspect of the invention makes it possible to obtain a circuit comprising two successive ducts in which a fluid circulates without it being necessary to machine said ducts to obtain a bent shape.

The two plates can be parallel to one another.

A plurality of junctions can be formed by means of the two plates, each junction requiring its own strap.

The junction system above is not limited to joining two ducts only but it can make it possible to connect one or more ducts to one or more other ducts. For example, in order to join three ducts, two ducts supplying fluid open into the space via two openings formed in one of the plates whereas another opening formed in said plate communicates with a duct via which the fluid leaves the space. The strap can in this case be arranged in the space so as to surround these three openings.

The system can thus make it possible to interconnect a variable number of ducts, which is difficult, or even impossible, by machining the ducts.

All or some of the features of the junction mentioned with respect to the heat exchanger apply to the junction system above.

The invention may be better understood on reading the detailed description which will follow of nonlimiting examples for implementing it and on examining the appended drawing, in which:

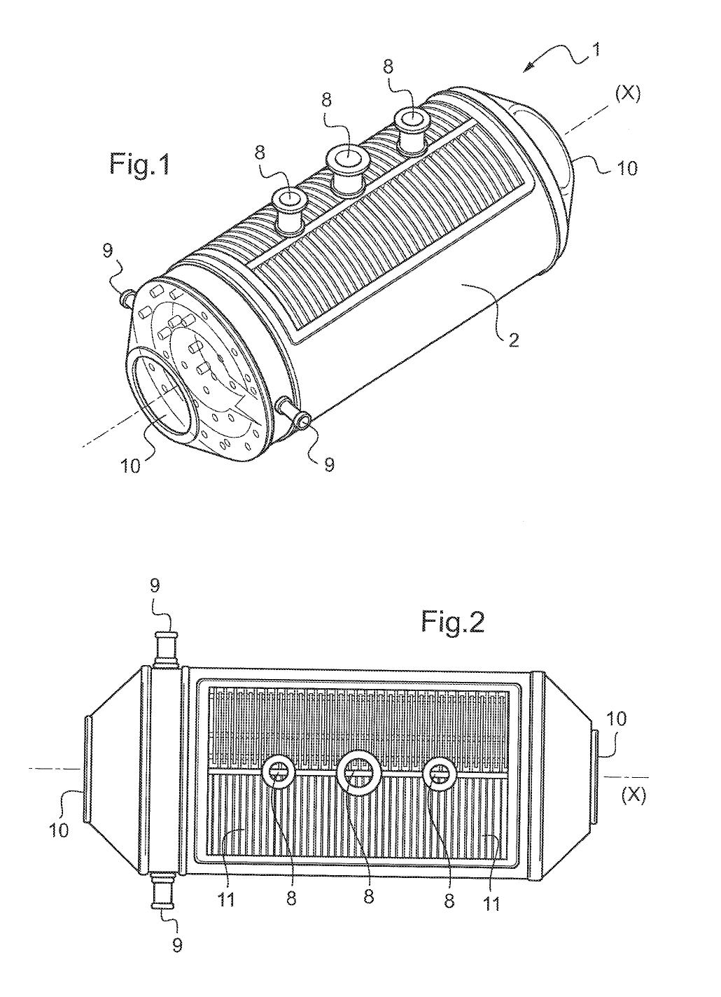

FIG. 1 is an elevation view of a reactor according to an exemplary embodiment of the invention,

FIG. 2 is a plan view of the reactor represented in FIG. 1,

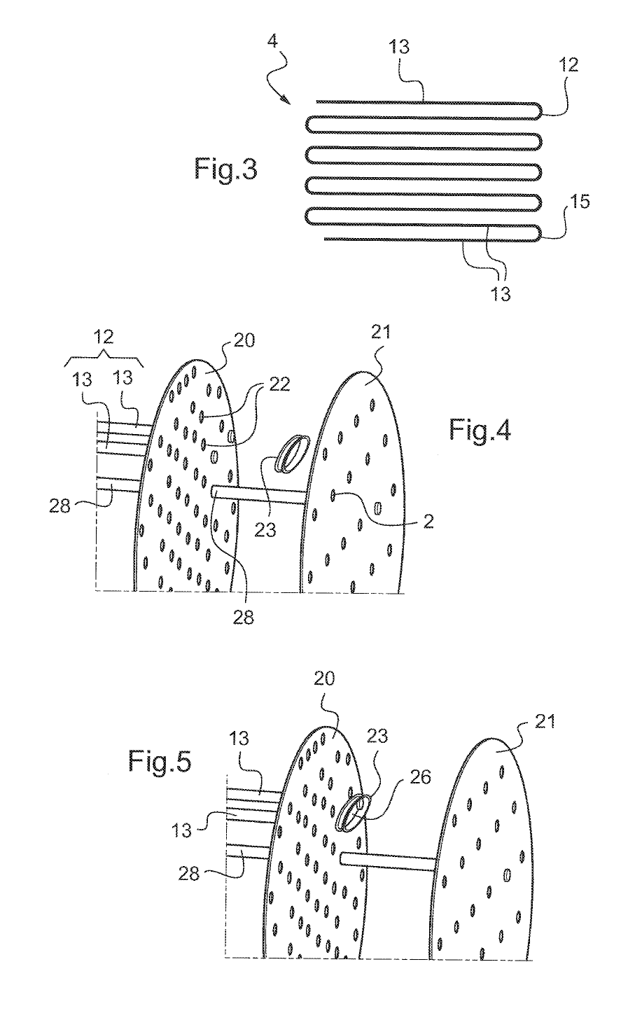

FIG. 3 schematically represents a unit of the second circuit,

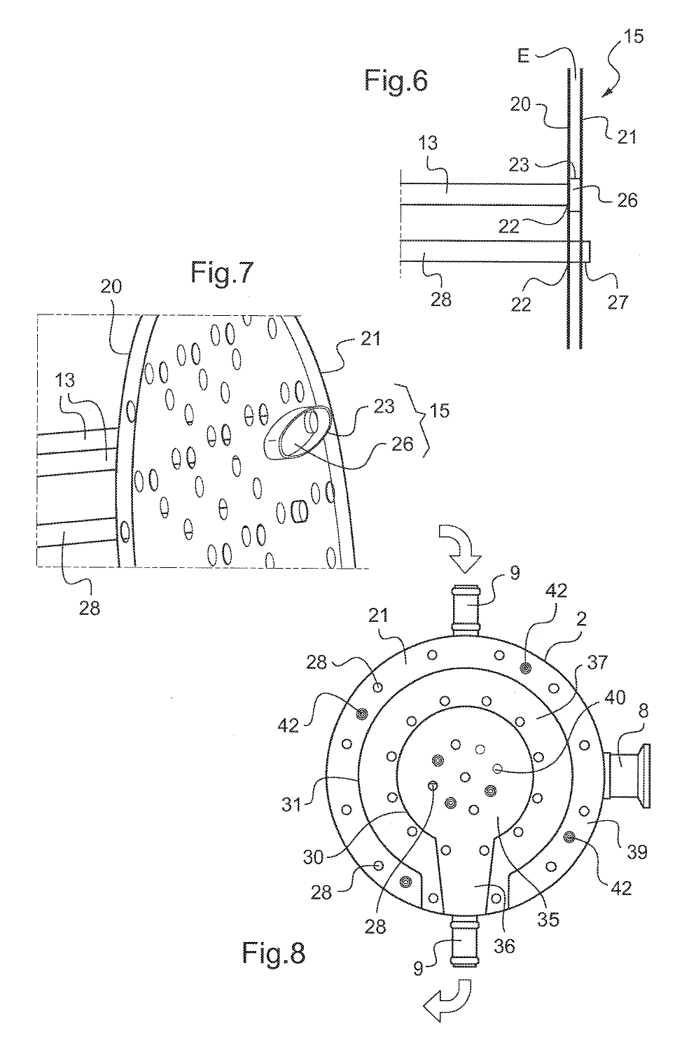

FIGS. 4 to 7 represent a plurality of steps when joining two ducts,

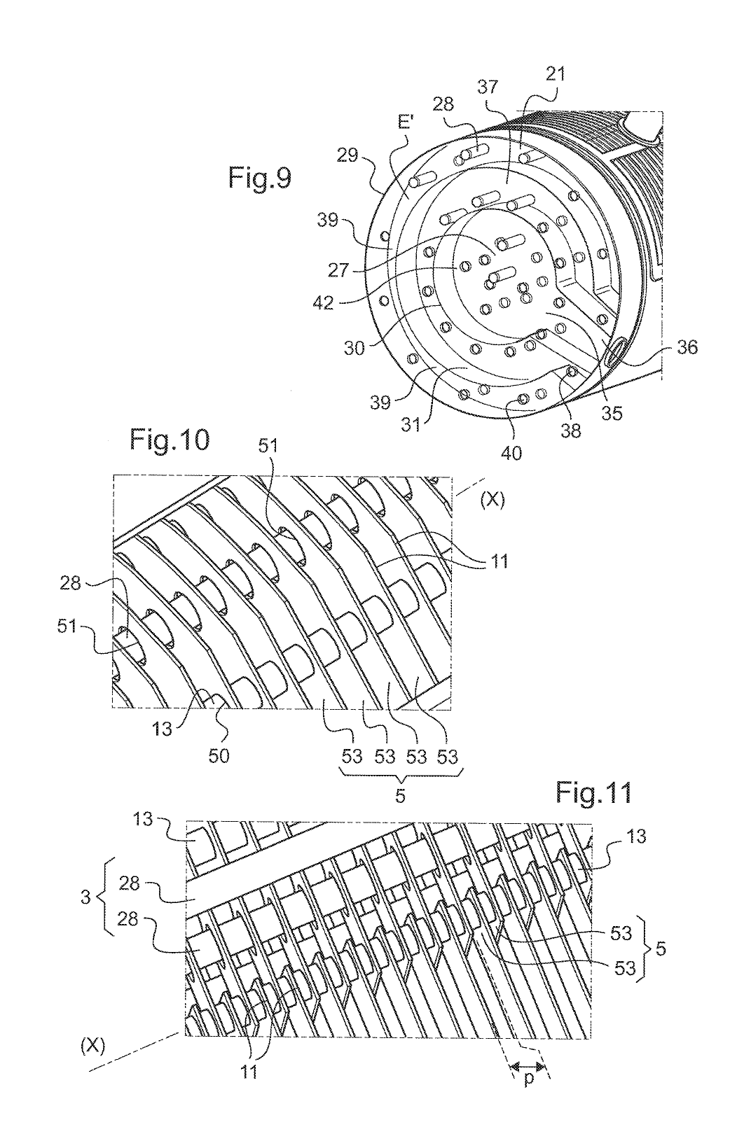

FIGS. 8 and 9 are respectively front and perspective views of a longitudinal end of the exchanger,

FIGS. 10 and 11 represent two examples of fins which can be used in the exchanger,

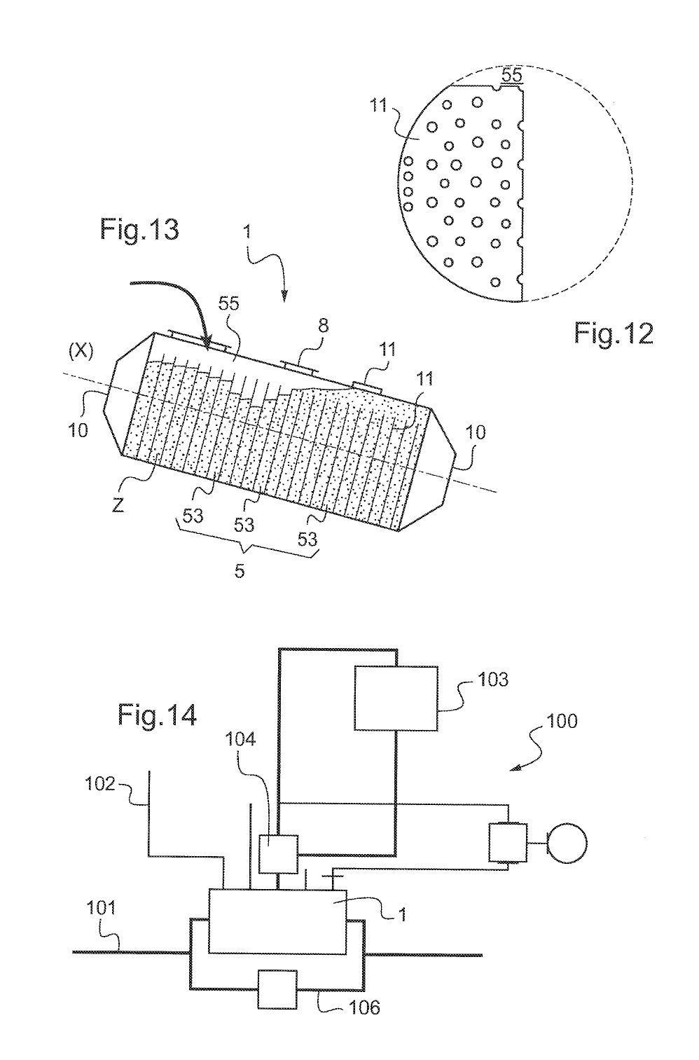

FIG. 12 represents another example of a fin in an isolated manner,

FIG. 13 represents in a highly schematic manner the exchanger of FIG. 1 provided with a plurality of fins according to that represented in FIG. 12, and

FIG. 14 represents in a schematic manner a system for heating a combustion engine comprising the exchanger described with reference to FIGS. 1 to 13.

FIG. 1 schematically represents a heat exchanger 1 according to an exemplary embodiment of the invention. This heat exchanger 1 has in this example a substantially cylindrical shape of longitudinal axis X with a cross section perpendicular to the axis X which is circular.

The heat exchanger 1 is intended in the example in question to be used to heat a vehicle combustion engine before or during its starting operation, as will be described subsequently with reference to FIG. 14.

The exchanger 1 comprises an enclosure 2, for example made of steel, inside which are arranged a first circuit 3, a second circuit 4 and a reservoir 5. The reservoir 5 can be formed by the gaps formed inside the enclosure 2 between the ducts belonging to the first circuit 3 or to the second circuit 4.

As represented in FIGS. 1 and 2, the enclosure 2 is provided with accesses toward its interior.

Three accesses 8 communicate for example with the reservoir 5 in order to fill the latter with a reagent Z and/or to supply the reservoir 5 with a fluid which reacts with the reagent, for example water. One of the accesses 8 can be used to measure the temperature in the enclosure, for example.

Two accesses 9 can be arranged at the same longitudinal end of the enclosure 2, on two opposite sides thereof. One of the accesses 9 can make it possible for a heat-transfer fluid, for example glycol water, to enter the second circuit 4 whereas the other access 9 makes it possible for the fluid having circulated in the second circuit 4 to leave this circuit.

As can be seen in FIGS. 1 and 2, two other accesses 10 formed axially can be provided, these accesses allowing the flow of exhaust gases along the axis X in the first circuit 3 of the exchanger 1.

The number of accesses 8, 9 and 10 mentioned above is not limiting.

The enclosure 2 may comprise, as in the example described, a cover which, when it is removed, makes it possible to gain access to the interior of said enclosure. In FIG. 2, the cover is removed, such that it is possible to observe fins 11 which will be described hereinbelow.

The reservoir 5 receives zeolite in the example in question. The reservoir can have a capacity which enables it to receive several kg of zeolites, for example between 1 and 6 kg of zeolite, in particular 2 kg of zeolite. The zeolite used can take the form of balls which are anhydrous before reacting with water.

The amount of zeolite can be sufficient to ensure that the zeolite in the reservoir is no further away than 15 mm from the first circuit 3.

An example of a second circuit 4 arranged in the enclosure 2 will now be described in more detail with reference to FIG. 3. This second circuit 4 can comprise a plurality of units 12 which can take the form of a layer of which only one is represented in FIG. 3.

In the example in question, the second circuit 4 comprises four units 12. Each unit 12 contains a succession of second ducts 13 arranged substantially parallel and connected at their ends by junctions 15 which will be described hereinbelow. Each second duct 13 can have substantially the same size. Each duct 13 has, for example, a circular cross section and an inside diameter between 6 and 8 mm with a wall having a thickness of less than 0.8 mm.

The units 12 can be superposed in the enclosure 2.

Each junction 15 can be formed by machining the ducts 13 to give them a bent shape. In a variant, a junction 15 can connect two rectilinear second ducts 13, as described with reference to FIGS. 4 to 8.

The junction 15 between two second ducts 13 can be obtained using a pair of plates 20 and 21. Each of these plates 20 or 21 can be made of steel and have a thickness of less than 0.5 mm. Each plate can have an oval or circular shape, this shape allowing it to be received in the enclosure 2. These two plates, which are parallel here, define a space E between them. The distance between the plates 20 and 21 is, for example, less than 1 cm, being in particular of the order of 5 mm.

In the example represented in FIGS. 4 to 7, the plate 21 is arranged between the plate 20 and the closest longitudinal end 29 of the enclosure 2.

In the example represented, the plate 20 comprises holes 22 allowing the passage, with a suitable fit, of the second ducts 13 connected by the junctions 15. This plate 20 receives the corresponding longitudinal ends of the two ducts 13, each of these longitudinal ends being arranged in a hole 22.

A strap 23 is fixed to this plate 20, for example by brazing, so as to externally delimit a part 26 of the space E, the two holes 22 opening into this part 26. The second plate 21 of the pair is then brought into contact with the strap 23, then fixed, in particular brazed, to the strap 23 so as to close the part 26.

The interaction between the strap 23 and the plates 20 and 21 thus forms a leaktight part 26 via which the fluid coming from a second duct 13 and reaching said part 26 of the space E through one hole 22 is redirected through the other hole 22 toward the other second duct 13. A junction 15 between the second ducts 13 is thus obtained.

As represented in FIGS. 4 to 7, the plate 20 is both traversed by the ends of the second ducts 13 connected to one another by the junctions and by the first ducts 28 of the first circuit 3 in which the exhaust gases can circulate. The other plate 21 is not traversed by the second ducts 13 connected to one another by the junctions 15.

The first ducts 28 can be brazed to each plate 20 and 21 whereas the second ducts 13 are then brazed only to the plate 20. In FIG. 7, the plate 21 not traversed by the second ducts 13 connected by the junctions 15 is represented in transparency in order to clarify the drawing.

The junction 15 which has just been described can be present at each longitudinal end of second ducts 13 in order to form the layer represented in FIG. 3.

The exchanger 1 comprises, for example, two pairs of plates 20 and 21, each of these pairs being situated at a longitudinal end 29 of the exchanger. All the junctions 15 of the second circuit 4 at each longitudinal end of the exchanger 1 can be formed by means of one or other of these pairs of plates.

A description will now be given with reference to FIGS. 8 and 9 of the way in which the accesses 9 toward the interior of the enclosure 2 are connected to the second circuit 4 to allow the circulation through the latter of the heat-transfer fluid. The accesses 9 open into a space E′, which is different from the space E mentioned above, and which is in the example of these figures delimited axially by the plate 21 and by another plate 27 arranged between the longitudinal end 29 of the enclosure 2 and the plate 21. In FIG. 9, this plate 27 is represented in transparency to allow the space E′ to be seen.

The plate 21 is then between the plate 20 and the plate 27.

In this example, the accesses 9 open into the space E′ in a diametrically opposed manner. As represented, two walls 30 and 31 interconnect the two plates 21 and 27. These walls divide the space E′ between the two plates 21 and 27 into three parts. A first part 35 mostly occupies a central zone of the space E′ with the exception of an extension 36 communicating with one of the accesses 9. This first part is surrounded externally by the wall 30.

A second part 37 mostly occupies a median zone of this space E′ with the exception of an extension 38. This second part is separated from the first part 35 by the wall 30.

Finally, a third part 39 occupies the periphery of the space E′ not occupied by the extensions 36 and 38. This third part 39 is contained radially between the wall of the enclosure 2 and the wall 31 and communicates with the other access 9.

In the example in question, the first part 35 defines an outlet manifold for the fluid. The latter exits the first part 35 via the access 9. The plate 21 furthest away from the longitudinal end 29 is provided with holes 40 in each of which is arranged the end of a second duct 13 forming a unit outlet 15. This plate is also provided with holes allowing the passage of the first ducts 28. On the other hand, the plate 27 has only the holes for allowing the passage of the first ducts 28. The fluid from the units 15 is thus collected in the first part 35 before leaving the exchanger via the access 9.

The third part 39 defines an inlet manifold for the fluid. Specifically, the plate 21 comprises a plurality of holes 42 in each of which is arranged the end of a second duct 13 forming the inlet of a unit 15.

The second part 37 is not provided with an access 9 but the first ducts 28 can pass through said second part.

A description will now be given with reference to FIGS. 10 and 11 of the fins 11 which can be integrated into the exchanger 1.

The fins 11 may or may not be arranged over the whole length of the enclosure 2. These fins 11 can be supports arranged perpendicularly to the longitudinal axis X with a spacing p between fins which may or may not be constant. The fins 11 then divide the reservoir 5 into compartments 53.

The thickness of each fin 11 may be less than 0.8 mm and the spacing p between fins 11 may be between 4 and 5.5 mm, whether or not this spacing is constant. When it is not constant, the spacing p may nevertheless remain between 4 and 5.5 mm.

In the example of FIGS. 10 and 11, the cross section perpendicular to the axis X of the enclosure 2 is circular and each fin 11 extends over less than half of said circular cross section, between a central zone of the enclosure comprising the axis X and an edge of the enclosure 2.

Two consecutive fins along the axis X may be arranged alternately with respect to the axis X, that is to say that one fin 11 arranged on one side of the axis X is flanked by two fins 11 arranged on the other side of the axis X, as can be seen in FIG. 11.

As represented, each fin 11 can come into contact with a plurality of second ducts 13. These second ducts 13 can traverse, without clearance, holes 50 formed in the fins 11. Again in the example represented, the fins 11 do not contact the first ducts 28, the latter being received in holes 51 formed in the fins 11 and having a size greater than the outside diameter of the first ducts 28. The first ducts 28 are then not retained in the enclosure 2 by the fins 11.

As represented in FIGS. 12 and 13, each fin 11 may occupy, in a plane perpendicular to the longitudinal axis X, less than the whole of the half cross section of the enclosure 2. The fins 11 can all have the same shape and can be arranged in pairs in the same way along the axis X in such a way that a passage 55 is formed along the whole length of the enclosure 2 by the portion of each half cross section of the enclosure 2 not occupied by the fins 11. The passage 55 can be formed along the axis X and be situated opposite to the accesses 8 to the reservoir 5. This passage 55 allows communication between the various compartments 53 of the reservoir 5, facilitating the filling thereof with reagent Z.

A description will now be given with reference to FIG. 14 of an example of using the combustion engine 1.

The combustion engine 1 forms part of a system 100 for heating a combustion engine. This system additionally comprises the exhaust line 101, a circuit 102 supplying the heat-transfer fluid to the combustion engine, and a condenser 103. The condenser 103 is connected to the accesses 8 toward the interior of the enclosure 2 via a valve 104.

When acting on the valve 104, water enters through the access or accesses 8 into the reservoir where it reacts with the zeolite in the anhydrous state present in the reservoir 5. This reaction corresponds to the adsorption of the water by the zeolite. The first drop of water vaporizes in contact with the anhydrous zeolite owing to the conditions in the exchanger, for example a pressure below 10 mbar and a temperature which can increase rapidly up to 250°. The heat released by this reaction is transferred by the fins 11 to the heat-transfer fluid circulating in the second circuit 4. This fluid reaches the outlet manifold formed by the first part 35 and then the circuit 102, bringing it close to the engine to heat the latter.

During this step, the exchanger 1 cannot be traversed by the exhaust gases, the exhaust line 101 comprising for this purpose a bypass 106 which is then traversed by the exhaust gases.

Regeneration of the zeolite can then be carried out. For this purpose, the exhaust gases are then directed through the exchanger 1, passing through the first circuit 3 between the two accesses 10. The exhaust gases release heat which is transferred through the ducts 28 to the zeolite of which the pores filled with water are desorbed. The water vapor enters the condenser 103 where it is condensed. Following this step, the water and the zeolite are again ready to react together to heat the engine during a subsequent starting operation.

The invention is not limited to the examples which have just been described.

The expression “comprising a” must be understood as meaning “comprising at least one”, unless otherwise specified.

1. A heat exchanger for a vehicle, the exchanger comprising:
a first circuit, a second circuit and a reservoir, the first circuit comprising first ducts capable of conveying exhaust gases; and
the second circuit comprising second ducts capable of conveying a heat-transfer fluid, wherein
the reservoir is capable of receiving a reagent and a reaction fluid engaging in the reservoir in an exothermic reaction with the reagent.

2. The exchanger as claimed in claim 1, the second circuit and the reservoir being arranged in such a way that, when the reagent is subjected to an exothermic reaction, the heat released by this reaction is transmitted to the fluid circulating in the second ducts.

3. The exchanger as claimed in claim 1, the first circuit and the reservoir being arranged in such a way that, when exhaust gases circulate in the first ducts, their heat is transmitted to the reagent in the reservoir.

4. The exchanger as claimed in claim 1, the first circuit comprising a plurality of first separate ducts extending substantially parallel to the longitudinal axis of the exchanger.

5. The exchanger as claimed in claim 1, the second circuit comprising at least one unit of second ducts connected to one another by junctions, the unit having one end forming an inlet of the unit and another end forming an outlet of the unit.

6. The exchanger as claimed in claim 5, each second duct extending substantially parallel to the longitudinal axis of the exchanger.

7. The exchanger as claimed in claim 6, the inlet and the outlet of the unit being situated at the same height along the longitudinal axis of the exchanger.

8. The exchanger as claimed in claim 5, at least one second duct opening at at least one of its longitudinal ends into a space delimited by a pair of plates arranged transversely, in particular perpendicularly, with respect to the longitudinal axis of the exchanger.

9. The exchanger as claimed in claim 8, comprising two pairs of plates, each pair being at a distance from the other pair along the longitudinal axis of the exchanger, each pair of plates defining a space into which open the corresponding longitudinal ends of all or part of the second ducts.

10. The exchanger as claimed in claim 8, the junction between two corresponding longitudinal ends of two second ducts being formed by means of a strap surrounding a part of the space delimited by the pair of plates, said longitudinal ends of said second ducts opening into this part of the space.

11. The exchanger as claimed in claim 10, the strap extending along the longitudinal axis of the exchanger over the whole distance between the two plates of the pair.

12. The exchanger as claimed in claim 1, comprising an inlet zone of the unit or units of the second circuit and an outlet zone of the unit or units of the second circuit.

13. The exchanger as claimed in claim 12, the inlet zone and the outlet zone being situated at the same height along the longitudinal axis of the exchanger.

14. The exchanger as claimed in claim 1, comprising a plurality of fins.

15. The exchanger as claimed in claim 14, each fin being in contact with at least one second duct and at a distance from the first ducts.

16. The exchanger as claimed in claim 15, each fin being in contact with a plurality of second ducts.

17. The exchanger as claimed in claim 14, the fins being arranged transversely, and perpendicularly with respect to the longitudinal axis of the exchanger.

18. The exchanger as claimed in claim 17, each fin having, in a plane transverse and perpendicular to the longitudinal axis of the exchanger, a cross section which is smaller than the cross section in this plane of the part of the exchanger in which it is arranged.

19. The exchanger as claimed in claim 1, the first circuit conveying exhaust gases, the second circuit conveying the heat-transfer fluid, and the reservoir receiving zeolite.

20. A method for heating a vehicle combustion engine with the aid of the heat exchanger as claimed in claim 1, comprising:
pouring reaction fluid into the reservoir into which there has previously been introduced a reagent engaging with said reaction fluid in an exothermic reaction; and
bringing the heat-transfer fluid heated after its passage through the second circuit into the vicinity of the combustion engine to be heated.
